(19) United States
(12) Patent Application Publication
(10) Pub. No.: US 2023/0137163 A1
(43) Pub. Date: May 4, 2023

(54) THERMAL RADIATION ELEMENT, THERMAL RADIATION ELEMENT MODULE, AND THERMAL RADIATION LIGHT SOURCE

(71) Applicant: TAMRON CO., LTD., Saitama (JP)

(72) Inventors: Shunya FUKUI, Saitama (JP); Jie LI, Saitama (JP)

(73) Assignee: TAMRON CO., LTD., Saitama (JP)

(21) Appl. No.: 17/944,701

(22) Filed: Sep. 14, 2022

(30) Foreign Application Priority Data
Oct. 28, 2021 (JP) 2021-176702
Aug. 22, 2022 (JP) 2022-132029

(51) Int. Cl. H05B 3/00; H05B 3/28; F27B 17/00; B32B 9/04

(52) U.S. Cl. CPC H05B 3/009; H05B 3/283; F27B 17/0016; B32B 9/04; B32B 9/041; H05B 2214/04; B32B 2307/202; B32B 2307/206; B32B 2307/732; B32B 2307/538; B32B 15/018

(57) ABSTRACT

A thermal radiation element includes a substrate, made of a semiconductor, having a first principal plane and a second principal plane, a first conductor layer and a second conductor layer provided on the first principal plane and the second principal plane, respectively, and an electrode pair provided in an outer edge region of the first conductor layer.

### CROSS-REFERENCE TO RELATED APPLICATIONS

This application is based on and claims the benefit of priority from Japanese Patent Application No. 2021-176702, filed on Oct. 28, 2021, and Japanese Patent Application No. 2022-132029, filed on Aug. 22, 2022, the entire contents of which are incorporated herein by reference.

### BACKGROUND OF THE INVENTION

### Technical Field

The present invention relates to a thermal radiation element. The present invention also relates to a thermal radiation element module and a thermal radiation light source including a thermal radiation element.

### Related Art

In recent years, techniques for obtaining optical property independent of a material by forming a microstructure on the surface of the material have widely been studied. One of the microstructures is a plasmonic structure, and a plasmonic perfect absorber has been reported as one of the plasmonic structures. The plasmonic perfect absorber is one that exhibits a high absorptance in a specific wavelength band out of the plasmonic structures. The plasmonic perfect absorber is a resonator structure in which a conductor, an insulator, and a conductor are stacked, and is also called a metal-insulator-metal (MIM) structure.

According to Kirchhoff's law, in opaque, the emissivity is equal to the absorptance. Therefore, it has also been reported that the emissivity on the surface of a material can be controlled using the MIM structure. The emissivity is expressed by a ratio of emissive power of a real surface to that of a black body surface. The thermal radiation on the black body surface is defined by Planck's law and is multiplied by the emissivity to obtain the thermal radiation on the real surface. Note that thermal radiation is a phenomenon in which thermal energy of an object is emitted as electromagnetic waves in accordance with the temperature of the object such as a black body and an MIM structure. Hereinbelow, radiation means thermal radiation unless otherwise specified.

As a conventional art document relating to emissivity control, JP 2018-136576 A can be cited, for example. JP 2018-136576 A relates to a technique for emitting thermal radiation of narrow-band infrared rays by means of emissivity control at a specific wavelength using an MIM structure.

Also, as described in JP 2020-64820 A, a thermal radiation light source to which a technique of emissivity control using an MIM structure is applied is known. JP 2020-64820 A relates to a technique for suppressing oxidation of an MIM structure that may occur in a case where the MIM structure is operated in the atmosphere by using a layer that suppresses oxidation as a surface layer.

Meanwhile, as illustrated in (b) of FIG. 1 in JP 2018-136576 A and FIG. 1 in JP 2020-64820 A, the MIM structure is stacked on a substrate (base in JP 2018-136576 A). Hereinbelow, the substrate and the MIM structure stacked on the substrate are collectively referred to as a thermal radiation element.

In order to utilize thermal radiation using such a thermal radiation element, it is essential to heat the MIM structure to a predetermined operating temperature. As the operating temperature is higher, the intensity of the thermal radiation is higher, and radiation on the shorter wavelength is emitted. The temperature is a balance of thermal energy. The temperature increases as the input amount of thermal energy gets larger than the loss amount thereof. In a case where the same materials have the same energy amounts, the amounts of temperature rise depend on the volumes. The thermal energy required to raise the temperature of an object by 1° C. is defined as Equation (1), where the heat capacity is C[J/° C.], the specific heat is c[J/kg·° C.], the density is ρ [kg/m³], and the volume is V[m³].

C=c×ρ×V (1)

### SUMMARY OF THE INVENTION

As methods for heating the MIM structure in the thermal radiation light source, JP 2020-64820 A described above describes a method of self-heating the substrate by energizing the substrate and a method of externally heating the substrate and the MIM structure using an external heating unit (for example, a heater). In any of these methods, heat passes through the substrate in the heat transfer path in the case of heating the MIM structure. In this manner, the substrate functions as a heat source for the MIM structure. Therefore, in order to cause the temperature of the MIM structure to reach the above-described operating temperature, it is necessary to keep the temperature of the substrate, which is a heat source, equal to or higher than the operating temperature.

Since the substrate is thicker than the MIM structure, the volume of the substrate is inevitably larger. That is, the heat capacity C of the substrate is inevitably larger than the heat capacity C of the MIM structure. Therefore, the conventional method of heating the entire MIM structure using the substrate as a heat source (for example, the method described in JP 2020-64820 A) has room for improving energy efficiency.

The present invention has been made in view of the above-described problems, and an object of an aspect of the present invention is to enhance energy efficiency as compared with the thermal radiation element in JP 2020-64820 A, which is a conventional thermal radiation element. An object of another aspect of the present invention is to provide a thermal radiation element module and a thermal radiation light source including a thermal radiation element having higher energy efficiency than a conventional thermal radiation element.

In order to solve the above-described problems, a thermal radiation element according to an aspect of the present invention includes a substrate, made of a semiconductor, having a first principal plane and a second principal plane, a first conductor layer and a second conductor layer provided on the first principal plane and the second principal plane, respectively, and an electrode pair provided in an outer edge region of the first conductor layer.

Also, in order to solve the above-described problems, a thermal radiation element module according to an aspect of the present invention includes the thermal radiation element according to the aspect of the present invention, and a housing provided with a cavity housing the thermal radiation element and a power terminal supplying power to the electrode pair. In the thermal radiation element module, a configuration is employed in which, in the inside of the cavity, at least a part of the substrate is secured to the cavity using a bonding member.

Further, in order to solve the above-described problems, a thermal radiation light source according to an aspect of the present invention includes the thermal radiation element module according to the aspect of the present invention.

According to an aspect of the present invention, energy efficiency can be enhanced as compared with the thermal radiation element in JP 2020-64820 A, which is a conventional thermal radiation element. Also, according to another aspect of the present invention, it is possible to provide a thermal radiation element module and a thermal radiation light source including a thermal radiation element having higher energy efficiency than a conventional thermal radiation element.

### BRIEF DESCRIPTION OF THE DRAWINGS

The upper diagram of FIG. 1 is a plan view of a thermal radiation element module according to an embodiment of the present invention, and the lower diagram of FIG. 1 is a cross-sectional view of the same thermal radiation element module;

FIG. 2 is a cross-sectional view of the thermal radiation element according to the embodiment of the present invention;

FIG. 3 is a plan view of the thermal radiation element illustrated in FIG. 2 as viewed from the side provided with an electrode pair;

FIG. 4 is an enlarged perspective view in which a part of a plasmonic perfect absorber included in the thermal radiation element illustrated in FIG. 2 is enlarged;

FIG. 5 is a cross-sectional view of a first modification example of the thermal radiation element illustrated in FIG. 2; and

FIG. 6 is a cross-sectional view of a second modification example of the thermal radiation element illustrated in FIG. 2.

### DESCRIPTION OF THE EMBODIMENTS

### First Embodiment

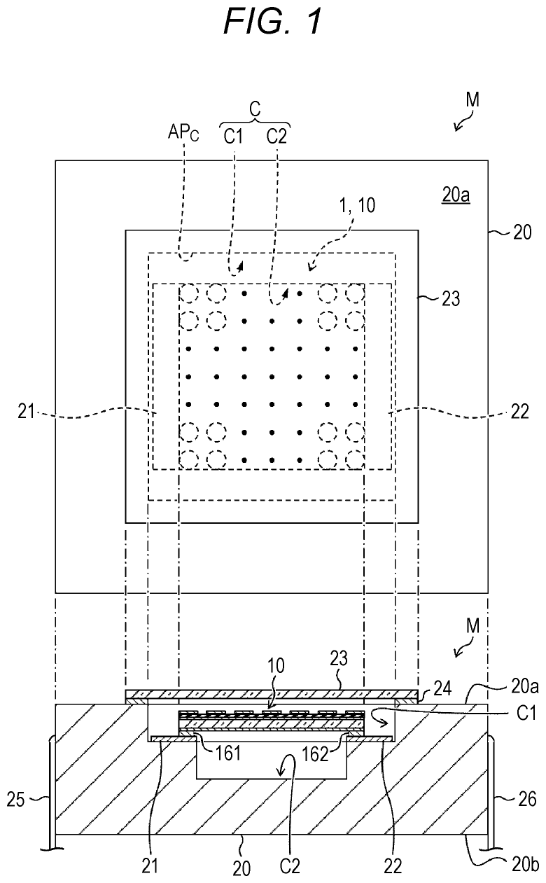

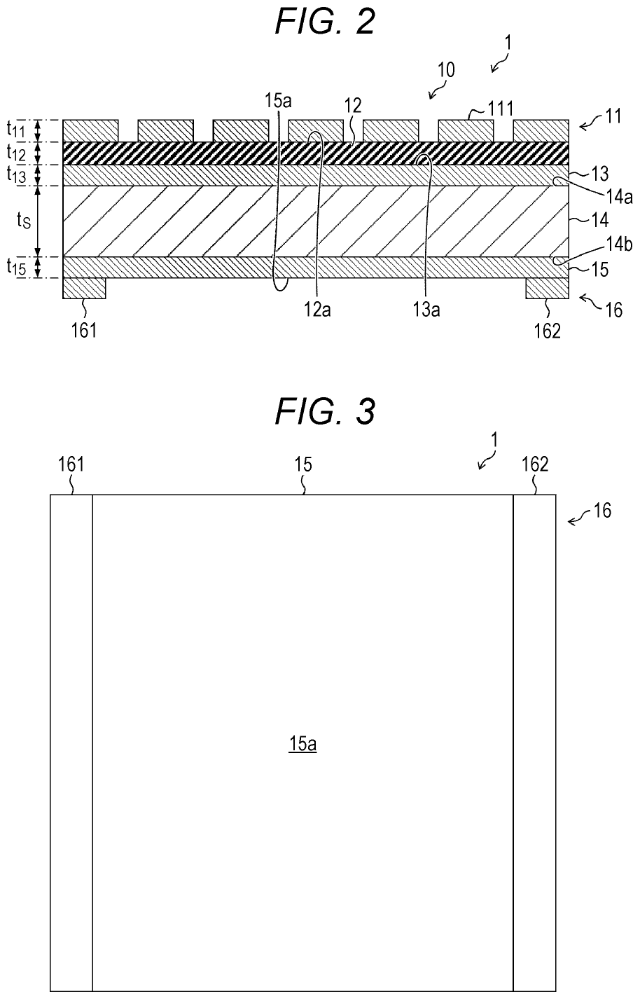

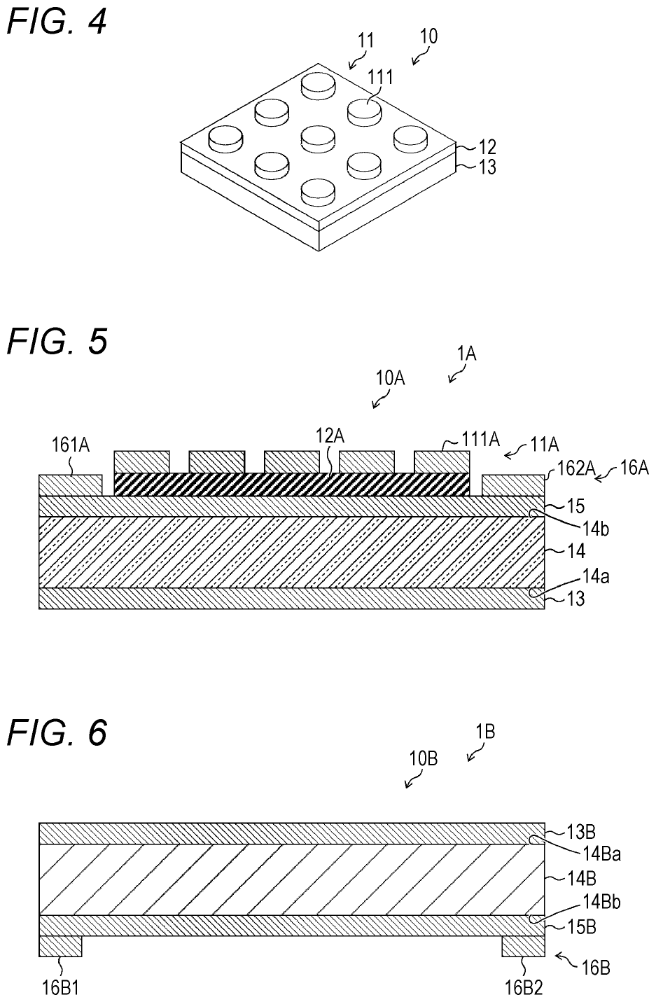

A thermal radiation element module M according to an embodiment of the present invention will be described with reference to FIGS. 1 to 4. The upper diagram of FIG. 1 is a plan view of the thermal radiation element module M, and the lower diagram of FIG. 1 is a cross-sectional view of the thermal radiation element module M. The plan view of the thermal radiation element module M is obtained in a case where an opening portion AP_{c} of a cavity C provided in a housing 20 is viewed in a planar view in the normal direction of the principal plane of an optical window 23. The cross-sectional view of the thermal radiation element module M is obtained in a cross section along the normal direction of the principal plane of the optical window 23 and including a thermal radiation element 1. FIG. 2 is a cross-sectional view of the thermal radiation element 1, and is an enlarged view of a portion of the thermal radiation element 1 in FIG. 1. In FIG. 2, the size of each component in the thickness direction is enlarged. FIG. 3 is a plan view of the thermal radiation element 1 as viewed from the side provided with an electrode pair 16. FIG. 4 is an enlarged perspective view in which a part of a plasmonic perfect absorber 10 included in the thermal radiation element 1 is enlarged.

[Overview of Thermal Radiation Element Module]

As illustrated in the upper diagram and the lower diagram of FIG. 1, the thermal radiation element module M includes the thermal radiation element 1, the housing 20, electrode pads 21 and 22, the optical window 23, a bonding member 24, and power terminals 25 and 26.

Here, the thermal radiation element 1, which is also an embodiment of the present invention, includes the plasmonic perfect absorber 10, a substrate 14, a conductor layer 15, and the electrode pair 16. Also, the plasmonic perfect absorber 10 includes a conductor layer 13, an insulator layer 12, and a conductor layer 11.

In a case where the conductor layer 13, the substrate 14, and the conductor layer 15 constituting a part of the plasmonic perfect absorber 10 are energized using the power terminals 25 and 26, the thermal radiation element module M emits electromagnetic waves (specifically, at least one of visible light, near-infrared light, mid-infrared light, and far-infrared light) caused by thermal radiation. In this manner, the thermal radiation element module M functions as a thermal radiation light source that emits electromagnetic waves of at least one of visible light, near-infrared light, mid-infrared light, and far-infrared light. That is, a thermal radiation light source using the thermal radiation element module M is also included in the scope of the present invention. Note that the thermal radiation light source may include not only the thermal radiation element module M but also a power supply module that supplies power to the thermal radiation element module M via the power terminals 25 and 26.

The thermal radiation element module M uses the power terminals 25 and 26 to cause current to flow in the in-plane direction of the conductor layer 15 in a temperature region near the room temperature and to cause current to flow in the in-plane directions of the conductor layers 13 and 15 in a temperature region near the operating temperature.

The current flowing in the in-plane directions of the conductor layers 13 and 15 generates Joule heat. Therefore, the thermal radiation element module M emits the above-described electromagnetic waves by heating the thermal radiation element 1 to a predetermined operating temperature using the thermal energy. The operating temperature of the thermal radiation element 1 can appropriately be determined within a temperature range in which the eutectic reaction in the plasmonic perfect absorber 10 does not proceed. The higher the operating temperature, the higher the intensity of the light emitted by the plasmonic perfect absorber 10. In the thermal radiation element 1 described in the present embodiment, the operating temperature is assumed to be 300° C. or more and 1200° C. or less.

<Substrate>

The substrate 14 is a plate-like member, made of a semiconductor, having a pair of principal planes 14a and 14b. In the state illustrated in FIG. 2, the principal plane 14a is located on the upper side, and the principal plane 14b is located on the lower side. The shape of the substrate 14 can appropriately be determined, but is preferably a rectangular shape or a square shape. In the present embodiment, a square is employed as the shape of the substrate 14.

In the present embodiment, silicon, which is an example of a semiconductor and has a resistivity of 1 nm, is employed as a material for the substrate 14. However, the material for the substrate 14 is not limited to silicon as long as the material is a semiconductor whose resistivity decreases with an increase in temperature. Also, the resistivity of the semiconductor can appropriately be determined in accordance with the configuration of the thermal radiation element 1 (for example, thicknesses of the conductor layer 13, the substrate 14, and the conductor layer 15), an assumed operating temperature, and the like. In the present embodiment, the resistivity of the semiconductor constituting the substrate 14 is preferably 1×10⁻² Ωm or more and 2 Ωm or less. Also, the resistivity of the semiconductor constituting the substrate 14 is preferably measured using a resistance measurement method conforming to a standard (such as a standard defined by Japanese Industrial Standards or American Society for Testing and Materials). By using the substrate 14 made of a semiconductor whose resistivity is guaranteed in this manner, it is possible to suppress variations in temperature characteristics that may occur in the manufactured thermal radiation element 1. The dopant doped in the semiconductor constituting the substrate 14 may be either n-type or p-type.

The substrate 14 has a high resistivity at room temperature. In the case of intrinsic silicon as an example of silicon, the resistivity at room temperature is about 1×10³ Ωm. Therefore, when the conductor layer 15 to be described below starts being energized, no current flows through the substrate 14, and current flows only through the conductor layer 15.

As described above, the resistivity of the substrate 14 decreases with an increase in temperature. In the case of intrinsic silicon, the resistivity at 300° C. is less than 1×10⁻¹ Ωm, the resistivity at 400° C. is less than 1×10⁻² Ωm, and the resistivity at 500° C. is about 1×10⁻³ Ωm. Therefore, since the resistivity of the substrate 14 decreases as the temperature of the substrate 14 increases, the current flows not only through the conductor layer 15 but also through the conductor layer 13.

In this manner, since parallel current paths of the conductor layer 13 and the conductor layer 15 are formed between an electrode 161 and an electrode 162 to be described below, the resistance value generated between the electrode 161 and the electrode 162 is obtained by combining the in-plane resistance value of the conductor layer 13, the in-plane resistance value of the conductor layer 15, and the perpendicular resistance value of the substrate 14 (resistance value between the conductor layer 13 and the conductor layer 15). In the thermal radiation element 1, by appropriately adjusting the thicknesses of the conductor layer 13, the substrate 14, and the conductor layer 15, it is possible to suppress a change in the resistance value generated between the electrode 161 and the electrode 162 at the operating temperature of the thermal radiation element 1. Therefore, in the thermal radiation element 1, the resistance value generated between the electrode 161 and the electrode 162 can be adjusted to any resistance value that can easily be monitored.

In addition, in the thermal radiation element 1, the temperature of the plasmonic perfect absorber 10 can be found by monitoring a resistance value that can be generated between the electrode 161 and the electrode 162. Since the spectrum of the electromagnetic waves emitted by the plasmonic perfect absorber 10 depends on the temperature of the plasmonic perfect absorber 10, in the thermal radiation element 1, a predetermined spectrum can be obtained by controlling the current supplied between the electrodes of the electrode pair 16 so that the resistance value that can be generated between the electrode 161 and the electrode 162 becomes a predetermined value.

As described above, in the thermal radiation element 1, since the resistance value generated between the electrode 161 and the electrode 162 can accurately be monitored, the temperature of the plasmonic perfect absorber 10 can easily be controlled. In addition, in the thermal radiation element 1, since it is not necessary to separately provide a thermometer for monitoring the temperature of the plasmonic perfect absorber 10, it is possible to reduce the size and cost of the thermal radiation element 1.

Note that a thickness tₛ (refer to FIG. 2) of the substrate 14 is preferably 100 μm or more and 1 mm or less. In the present embodiment, the thickness tₛ is 200 μm.

The principal plane 14a is provided with the plasmonic perfect absorber 10 in which the conductor layer 13, the insulator layer 12, and the conductor layer 11 are stacked in this order. The plasmonic perfect absorber 10 will be described below. On the other hand, the principal plane 14b is provided with the conductor layer 15 and the electrode pair 16 stacked in this order. The conductor layer 15 and the electrode pair 16 will be described below. The principal plane 14b and the principal plane 14a are examples of a first principal plane and a second principal plane, respectively.

<First Conductor Layer>

As illustrated in FIGS. 2 and 3, the conductor layer 15 is provided so as to cover the entire region of the principal plane 14b. In an aspect of the present invention, a first conductor layer refers to a conductor layer on which the electrode pair is stacked. Therefore, the conductor layer 15 is an example of the first conductor layer. The conductor layer 15 has current flow therethrough in the in-plane direction using the electrode pair 16 to be described below to function as a heater that heats the plasmonic perfect absorber 10 and the substrate 14. Hence, the conductor constituting the conductor layer 15 preferably has a higher resistivity than copper, aluminum, gold, or the like. Also, a semiconductor has a characteristic of easily becoming a eutectic alloy with various metals. For example, tungsten, which has a melting point of 3422° C., exhibits a eutectic reaction with silicon at 650° C. or lower to cause the resistivity to be changed. For this reason, a preferable conductor constituting the conductor layer 15 is one whose temperature for a eutectic reaction with a semiconductor is high. Preferable examples of the conductor constituting the conductor layer 15 include hafnium nitride (HfN), titanium nitride (TiN), and molybdenum (Mo).

<Electrode Pair>

As illustrated in FIGS. 2 and 3, the electrodes 161 and 162 constituting the electrode pair 16 are provided on a principal plane 15a, which is a principal plane (lower principal plane in FIG. 2) on the opposite side of the substrate 14 out of the principal planes of the conductor layer 15.

The electrodes 161 and 162 are provided in the outer edge region of the conductor layer 15 in order to cause current to flow throughout the conductor layer 15. The outer edge region of the conductor layer 15 is an annular region along the four sides forming the conductor layer 15. More specifically, the electrodes 161 and 162 are provided along a pair of opposite sides (a pair of opposite sides located on the left side and the right side in FIG. 3) of the conductor layer 15 formed in a square shape similarly to the substrate 14. Each of the electrodes 161 and 162 is a strip-shaped or rectangular conductor pattern. The electrode 161 is provided along a side located on the left side in FIG. 3, and the electrode 162 is provided along a side located on the right side in FIG. 3.

In the present embodiment, a three-layer film of Ti/Pt/Au in which titanium (Ti), platinum (Pt), and gold (Au) are stacked in this order on the principal plane 15a is used as each of the electrodes 161 and 162. The thickness of each layer can appropriately be determined, but in the present embodiment, the thicknesses of Ti and Pt are 30 nm, and the thickness of Au is 500 nm.

By connecting wires having different polarities to the electrodes 161 and 162, respectively, and supplying power, current flows from one of the electrodes 161 and 162 to the other. That is, current flows through the conductor layer 15 in the in-plane direction of the principal plane 15a. Therefore, the electrodes 161 and 162 provided on the principal plane 15a of the conductor layer 15 are an example of an electrode that allows current to flow in the in-plane direction of the principal plane of the conductor layer 15.

Note that, in the present embodiment, a three-layer film of Ti/Pt/Au described above, which is an example of a multilayer film, is used as each of the electrodes 161 and 162. Here, each of the Ti and Pt layers functions as an underlayer, and the Au layer functions as a main conductive layer. The Ti layer serving as the underlayer enhances adhesion of the electrodes 161 and 162 to the conductor layer 15 and reduces contact resistance that may be generated between the conductor layer 15 and the electrodes 161 and 162. Also, the Pt layer serving as the underlayer prevents or suppresses diffusion that may be generated between the Au layer and the Ti layer and suppresses changes in the resistance of the electrodes. However, the constitution of the underlayer is not limited to Ti/Pt. The underlayer may be constituted by a single-layer film or a multilayer film of three or more layers. Also, a different metal can be used instead of Au as a layer that functions as the main conductor layer. For example, Ag or an alloy consisting primarily of Ag can be used. Further, in each of the electrodes 161 and 162, the Ti/Pt underlayer may be omitted, and a single-layer film of Au can be employed. The configuration of each of the electrodes 161 and 162 is not limited to the above-described example, and can appropriately be determined in consideration of how high the conductivity is, how low the reactivity is, how high the melting point is, and the like.

<Plasmonic Perfect Absorber>

As illustrated in FIG. 4, the plasmonic perfect absorber 10 included in the thermal radiation element 1 includes the conductor layer 11, the insulator layer 12, and the conductor layer 13. The conductor layer 11 is an example of a third conductor layer, and the conductor layer 13 is an example of a second conductor layer. On the principal plane 14a of the substrate 14, the conductor layer 13, the insulator layer 12, and the conductor layer 11 are stacked in this order.

(Second Conductor Film)

The conductor layer 13 is a film, made of a conductor, formed on the principal plane 14a, which is one principal plane (upper principal plane in FIG. 2) of the substrate 14, so as to cover the entire region of the principal plane 14a. The conductor layer 13 is an example of the second conductor layer.

In the present embodiment, hafnium nitride (HfN) is employed as the conductor constituting the conductor layer 13. However, the conductor constituting the conductor layer 13 is not limited to HfN as long as the conductor is a material having metallic conductive characteristics. In a case where the plasmonic perfect absorber 10 is formed on the surface of a base material which is assumed to have a high temperature at the time of use, the material for the conductor layer 13 is preferably a material having a high melting point such as HfN. A typical melting point of HfN is 3330° C. In addition, a preferable material for the conductor layer 13 is one whose temperature for a eutectic reaction with a semiconductor is high, such as HfN. HfN exhibits no eutectic reaction with silicon in a temperature range of 1200° C. or lower.

Note that the region of the principal plane 14a in which the conductor layer 13 is formed may be the entire principal plane 14a or a part of the principal plane 14a, and can appropriately be determined. In the present embodiment, the conductor layer 13 is formed on the entire principal plane 14a.

In the present embodiment, a thickness t₁₃ (refer to FIG. 2) of the conductor layer 13 is 140 nm. However, the thickness t₁₃ is not limited to 140 nm, and can appropriately be determined within a range of, for example, 10 nm or more and 10 μm or less. Note that the thickness t₁₃ is an example of a thickness t1 described in the claims.

(Insulator Film)

The insulator layer 12 is a film, made of an insulator, formed on a principal plane 13a, which is a principal plane (upper principal plane in FIG. 2) on the opposite side of the substrate 14 out of the principal planes of the conductor layer 13, so as to cover at least a part of the principal plane 13a. In the present embodiment, as illustrated in FIG. 2, the insulator layer 12 is provided so as to cover the entire region of the principal plane 13a. However, the region of the principal plane 13a in which the insulator layer 12 is provided may be the entire principal plane 13a or a part of the principal plane 13a, and can appropriately be determined.

Note that, in the present embodiment, the insulator layer 12 which is a solid film having a uniform thickness is formed. However, the insulator layer 12 may be formed only in regions in which a plurality of conductor patterns 111 are formed. That is, similarly to the conductor layer 11, the insulator layer 12 may include a plurality of conductor patterns regularly arranged, the plurality of conductor patterns each being in a circular shape or a regular polygonal shape.

In the present embodiment, SiO₂ is employed as a material for the insulator layer 12. However, the material for the insulator layer 12 is not limited to SiO₂ as long as the material is an insulator. An example of such a material includes an insulating oxide. In a case where the plasmonic perfect absorber 10 is formed on the principal plane 14a of the substrate 14 which is assumed to have a high temperature at the time of use, the material for the insulator layer 12 is preferably any of SiO₂, aluminum oxide (Al₂O₃), aluminum nitride (AlN), and a mixture of SiO₂ and Al₂O₃.

In the present embodiment, a thickness t₁₂ (refer to FIG. 2) of the insulator layer 12 is 180 nm. However, the thickness t₁₂ is not limited to 180 nm, and can appropriately be determined within a range of, for example, 10 nm or more and 10 μm or less.

(Third Conductor Layer)

The conductor layer 11 is formed over the entire region of a principal plane 12a, which is a principal plane (upper principal plane in FIG. 2) on the opposite side of the insulator layer 12 out of the principal planes of the insulator layer 12. However, the region of the principal plane 12a in which the conductor layer 11 is provided may be the entire principal plane 12a or a part of the principal plane 12a, and can appropriately be determined. The conductor layer 11 is an example of a third conductor layer. In this manner, the insulator layer 12 and the conductor layer 11 described above are stacked on the principal plane 13a of the conductor layer 13, which is an example of the second conductor layer, in this order.

The conductor layer 11 includes the plurality of (nine in FIG. 4) conductor patterns 111 each formed in a circular shape. However, the shape of each of the conductor patterns 111 is not limited to the circular shape, and may be a regular polygonal shape. A preferable example of the regular polygonal shape includes a regular hexagonal shape.

Note that reference sign 111 is given to only one conductor pattern 111 out of the plurality of conductor patterns 111. As illustrated in FIG. 4, the plurality of conductor patterns 111 are two-dimensionally and regularly arranged on the principal plane 12a. In the present embodiment, as illustrated in FIG. 4, a square arrangement is employed as the two-dimensional and regular arrangement of the conductor patterns 111. However, the two-dimensional and regular arrangement is not limited to the square arrangement, and may be, for example, a hexagonal arrangement.

In the present embodiment, hafnium nitride (HfN) is employed as the conductor constituting each conductor pattern 111 of the conductor layer 11. However, the conductor constituting each conductor pattern 111 is not limited to HfN as long as the conductor is a material having metallic conductive characteristics. In this respect, the conductor constituting each conductor pattern 111 is the same as the conductor constituting the conductor layer 13.

Also, in the present embodiment, a thickness t₁₁ (refer to FIG. 2, that is, the thickness of each of the conductor patterns 111) of the conductor layer 11 is 40 nm. However, the thickness t₁₁ is not limited to 40 nm, and can appropriately be determined within a range of, for example, 10 nm or more and 10 μm or less. Note that the thickness t₁₁ is an example of a thickness t₃ described in the claims.

Also, the thickness t₁₃ of the conductor layer 13 and the thickness t₁₁ of the conductor layer 11 preferably satisfy the relationship of t₁₃>1.5×t₁₁. The thickness t₁₁ is an example of a thickness t3 of the third conductor layer, and the thickness t₁₃ is an example of a thickness t1 of the first conductor layer.

<Housing>

The housing 20 is a rectangular solid block. In the present embodiment, the material for the housing 20 is alumina, which is an example of ceramic. However, the ceramic constituting the housing 20 is not limited to alumina, and can appropriately be selected. In addition, the material for the housing 20 is not limited to ceramic, and may be metal, an alloy, or an organic compound such as resin. However, in a case where the operating temperature of the thermal radiation element 1 is set to 150° C. or higher, the material for the housing 20 is preferably any of metal, an alloy, and ceramic.

Out of the paired principal planes of the housing 20, the principal plane located on the upper side in the state illustrated in FIG. 1 is referred to as a principal plane 20a, and the principal plane located on the lower side in the state illustrated in FIG. 1 is referred to as a principal plane 20b. The principal plane 20a is provided with the cavity C. The depth of the cavity C is smaller than the thickness of the housing 20. Therefore, the cavity C does not penetrate the principal plane 20b.

The cavity C includes two sub-cavities C1 and C2.

The sub-cavity C1 is formed in a region closer to the principal plane 20a (that is, a shallow region). The sub-cavity C2 is formed in a region farther from the principal plane 20a than the sub-cavity C1 (that is, a deep region). The size of the opening portion AP_{c} of the sub-cavity C1 is determined so as to be able to include the thermal radiation element 1 in a planar view. Note that the reference sign AP_{c} is clearly illustrated in the upper diagram of FIG. 1, but illustration of AP_{c} is omitted in the lower diagram of FIG. 1.

On the other hand, the size of the opening portion of the sub-cavity C2 formed on the bottom surface of the sub-cavity C1 is determined so as to be included by the thermal radiation element 1 in a planar view. The cavity C configured in this manner is formed in a stepped shape.

In the sub-cavity C1 of the cavity C, the thermal radiation element 1 is housed. The bottom wall of the sub-cavity C1 is provided with the electrode pads 21 and 22 that are in partial contact with the electrodes 161 and 162. In the thermal radiation element 1, the electrodes 161 and 162 constituting a part of the substrate 14 are respectively secured to the electrode pads 21 and 22 provided on the bottom wall of the sub-cavity C1 using conductive bonding members. That is, the electrodes 161 and 162 are electrically connected to the electrode pads 21 and 22, respectively.

Note that the electrode pads 21 and 22 provide electric power to the electrodes 161 and 162, and at the same time, transfer thermal energy generated in the thermal radiation element 1 to the housing 20. To suppress heating of the housing 20 due to the thermal transfer, the contact area between the electrode pads 21 and 22 and the electrodes 161 and 162 is preferably small. On the other hand, if the contact area is too small, the contact resistance between the electrode pads 21 and 22 and the electrodes 161 and 162 becomes too large. This contact area can appropriately be set in view of the extent of the thermal transfer from the thermal radiation element 1 to the housing 20 and the level of the contact resistance between the electrode pads 21 and 22 and the electrodes 161 and 162.

In the present embodiment, a silver (Ag) paste, which is a sintered bonding material, is employed as the bonding member. By heating the sintered silver paste to about 200° C., objects can be bonded to each other in a non-pressurized state. The silver paste used in the present embodiment has heat resistance to withstand the operating temperature of the thermal radiation element 1 (for example, any temperature of 300° C. or more and 900° C. or less) when sintered, and is thus preferable as a bonding member. Note that, in the lower diagram of FIG. 1, illustration of the bonding member is omitted.

In this manner, since the thermal radiation element 1 has a high operating temperature, in order to enhance energy efficiency, it is preferable to suppress thermal energy dissipated by thermal transfer from the thermal radiation element 1 to the housing 20. In the thermal radiation element module M, since the sub-cavity C2 as well as the sub-cavity C1 is formed in the housing 20, it is possible to limit the path for thermal transfer that can be formed between the thermal radiation element 1 and the housing 20.

Note that, in the present embodiment, the electrode pads 21 and 22 are in contact with parts of the electrodes 161 and 162, respectively. By limiting the contact area between the electrodes 161 and 162 and the electrode pads 21 and 22, the path for thermal transfer can be limited between the electrode pads 21 and 22 and the electrodes 161 and 162.

As illustrated in the lower diagram of FIG. 1, the housing 20 is provided with the power terminals 25 and 26. The power terminal 25 is inserted from the outside into the inside of the housing 20. In addition, the tip of the power terminal 25 is electrically connected to the electrode pad 21. Similarly, the power terminal 26 is inserted from the outside into the inside of the housing 20. In addition, the tip of the power terminal 26 is electrically connected to the electrode pad 22. Note that the portions at which the power terminals 25 and 26 are respectively inserted into the housing 20 are sealed so as to maintain sealing performance.

As illustrated in the upper view and the lower view of FIG. 1, the opening portion AP_{c} is covered with the optical window 23. The material for the optical window 23 preferably has translucency and heat resistance to withstand the temperature that the housing 20 is to reach (for example, any temperature of 270° C. or less), and in the present embodiment, a plate-like member made of borosilicate glass is used.

The optical window 23 is bonded to the principal plane 20a of the housing 20 using the bonding member 24. In the present embodiment, gold (Au) tin (Sn) solder is used as the bonding member 24. That is, the opening portion AP_{c} is sealed by the optical window 23.

Also, the thermal radiation element module M is configured so that the pressure inside the cavity C is lower than the pressure outside the cavity C (for example, the atmospheric pressure). This configuration can be achieved, for example, by sealing the cavity C under a reduced pressure environment in which the pressure is lower than the atmospheric pressure. The pressure inside the cavity C is not limited, but is preferably 1×10³ Pa or less, and more preferably 1×10¹ Pa or less. As the pressure inside the cavity C is lower, the heat insulating property of the cavity C can be enhanced.

[Sum-Up]

The thermal radiation element 1 according to an aspect of the present invention includes the substrate 14, made of a semiconductor (made of silicon in the present embodiment), having the principal plane 14b, which is an example of a first principal plane, and the principal plane 14a, which is an example of a second principal plane, a first conductor layer (conductor layer 15) and a second conductor layer (conductor layer 13) provided on the first principal plane (principal plane 14b) and the second principal plane (principal plane 14a), respectively, and the electrode pair 16 provided in an outer edge region of the first conductor layer (conductor layer 15).

According to this configuration, since the resistivity of the substrate 14 decreases in a state where the plasmonic perfect absorber 10 has reached the operating temperature, the conductor layer 13 as well as the conductor layer 15 is used as a heat source. In this manner, since the conductor layer 13 constituting a part of the plasmonic perfect absorber 10 can directly be used as a heat source, the thermal radiation element 1 can enhance energy efficiency as compared with the thermal radiation element in Patent Document 2, which is a conventional thermal radiation element.

Also, in the thermal radiation element 1, the resistance value that can be generated between the electrode 161 and the electrode 162 is obtained by combining the in-plane resistance values of the conductor layer 13 and the conductor layer 15, and the perpendicular resistance value of the substrate 14 (resistance value between the conductor layer 13 and the conductor layer 15). Therefore, the resistance value that can be generated between the electrode 161 and the electrode 162 can be set to any resistance value that can easily be monitored regardless of the in-plane resistance values of the conductor layer 13 and the conductor layer 15.

Accordingly, in the thermal radiation element 1, since the resistance value generated between the electrode 161 and the electrode 162 can accurately be monitored, the temperature of the plasmonic perfect absorber 10 can easily be controlled.

In addition, in the thermal radiation element 1, since it is not necessary to separately provide a thermometer for monitoring the temperature of the plasmonic perfect absorber 10, it is possible to reduce the size and cost of the thermal radiation element 1.

The thermal radiation element 1 further includes the insulator layer 12 and a third conductor layer (conductor layer 11) stacked in order on a surface (principal plane 13a of the conductor layer 13 in the present embodiment) of the second conductor layer (conductor layer 13), the insulator layer 12 and the third conductor layer (conductor layer 11) constituting the plasmonic perfect absorber 10 together with the second conductor layer (conductor layer 13) (together with the conductor layer 13 in the present embodiment).

According to this configuration, the spectrum of the electromagnetic waves emitted by the thermal radiation element 1 can be controlled by appropriately setting each parameter of the plasmonic perfect absorber.

Note that, as described below with reference to FIG. 5, a modification example of the thermal radiation element 1 may further include an insulator layer 12A and the third conductor layer (conductor layer 11A) stacked in order on the principal plane 15a, which is a surface of the first conductor layer (conductor layer 15), the insulator layer 12A and the third conductor layer (conductor layer 11A) constituting a plasmonic perfect absorber 10A together with the first conductor layer (conductor layer 15). That is, the plasmonic perfect absorber may be provided on the second conductor layer (conductor layer 13) or on the first conductor layer (conductor layer 15).

Further, in the thermal radiation element 1, a configuration is employed in which the third conductor layer (conductor layer 11) includes the plurality of conductor patterns 111 two-dimensionally and regularly arranged, the plurality of conductor patterns 111 each being in a circular shape or a regular polygonal shape.

According to this configuration, the wavelength range of the light emitted from the plasmonic perfect absorber 10 can be adjusted by adjusting the size and the regular arrangement of the plurality of conductor patterns 111.

Also, in the thermal radiation element 1, a configuration is employed in which the thickness t1 (t₁₃) of the conductor layer (conductor layer 13), out of the first conductor layer (conductor layer 15) and the second conductor layer (conductor layer 13), constituting the plasmonic perfect absorber 10 together with the insulator layer 12 and the third conductor layer (conductor layer 11), and the thickness t3 (t₁₁) of the third conductor layer (conductor layer 11) satisfy the relationship of t1>1.5×t3 (t₁₃>1.5×t₁₁).

According to this configuration, since the resistance value of the conductor layer 13 can appropriately be lowered, large current easily flows through the conductor layer 13. Therefore, the thermal energy generated in the conductor layer 13 can be increased.

Also, in the thermal radiation element 1, a configuration is employed in which the conductor layer (conductor layer 13 in the present embodiment), out of the first conductor layer (conductor layer 15) and the second conductor layer (conductor layer 13), constituting the plasmonic perfect absorber 10 together with the insulator layer 12 and the third conductor layer (conductor layer 11), and the third conductor layer (conductor layer 11) are made of HfN.

HfN is known to have a high melting point and to be less likely to exhibit a eutectic reaction with a semiconductor. Therefore, according to this configuration, it is possible to suppress the eutectic reaction that can proceed with the semiconductor constituting the substrate 14. Therefore, the operating temperature of the thermal radiation element 1 can be increased.

In the thermal radiation element 1, a configuration is employed in which the insulator layer 12 is made of at least one of SiO₂, Al₂O₃, and AlN.

According to this configuration, the insulator layer 12 having a high insulating property can easily be formed.

Also, in the thermal radiation element 1, a configuration is employed in which the thickness tₛ of the substrate 14 is 100 μm or more and 1 mm or less.

According to this configuration, the resistance value that can be generated between the electrode 161 and the electrode 162 can be adjusted to any resistance value that can easily be monitored.

Also, in the thermal radiation element 1, a configuration is employed in which the substrate 14 is made of silicon.

According to this configuration, the cost of the substrate 14 can be suppressed. Also, by appropriately setting the doping amount of the dopant and the thickness of the substrate, it is possible to easily adjust the perpendicular resistance value of the substrate 14.

The thermal radiation element module M according to an aspect of the present invention includes the thermal radiation element 1, and the housing 20 provided with the cavity C housing the thermal radiation element 1 and the power terminals 25 and 26 supplying power to the electrodes 161 and 162 serving as an electrode pair. In the thermal radiation element module M, a configuration is employed in which, in the inside of the cavity C, at least a part of the substrate 14 is secured to the cavity C using a bonding member. Specifically, the electrodes 161 and 162 are secured to the electrode pads 21 and 22 using a bonding member (sintered silver paste), respectively.

The thermal radiation element module M configured as described above has a similar effect to that of the thermal radiation element 1. Also, the thermal radiation element included in the thermal radiation element module M is not limited to the thermal radiation element 1, and may be a thermal radiation element 1A illustrated in FIG. 5 or a thermal radiation element 1B illustrated in FIG. 6. The thermal radiation elements 1A and 1B will be described below.

In the thermal radiation element module M, a configuration is employed in which, in a case where the opening portion AP_{c} of the cavity C is viewed in a planar view (refer to the upper diagram of FIG. 1), the opening portion AP_{c} includes the thermal radiation element 1, the opening portion AP_{c} is sealed by the optical window 23 having translucency, and the pressure inside the cavity C is lower than the pressure outside the cavity C.

According to this configuration, since the heat insulating property of the cavity C can be enhanced as compared with a case where the pressure inside the cavity C is equal to or higher than the pressure outside the cavity C, the thermal energy generated by the conductor layer 13 can be restricted from being dissipated to the outside of the cavity C. Accordingly, the energy efficiency of the entire thermal radiation element module M can be enhanced.

Also, in the thermal radiation element module M, the thermal radiation element 1 is heated to a predetermined operating temperature using thermal energy generated by the conductor layer 13 and the conductor layer 15 to cause electromagnetic waves (specifically, at least one of visible light, near-infrared light, mid-infrared light, and far-infrared light) caused by thermal radiation to be emitted. In this manner, the thermal radiation element module M functions as a thermal radiation light source that emits electromagnetic waves of at least one of visible light, near-infrared light, mid-infrared light, and far-infrared light. That is, a thermal radiation light source including the thermal radiation element module M is also included in the scope of the present invention.

Here, the effect achieved by an aspect of the present invention has been described using the thermal radiation element 1 illustrated in FIGS. 1 and 2. However, the effect of the thermal radiation element 1 described above can similarly be obtained in the thermal radiation elements 1A and 1B described below.

### First Modification Example

The thermal radiation element 1A according to a first modification example of the thermal radiation element 1 will be described with reference to FIG. 5. FIG. 5 is a cross-sectional view of the thermal radiation element 1A, which is a cross-sectional view corresponding to FIG. 2 illustrating the thermal radiation element 1.

In the thermal radiation element 1 illustrated in FIG. 2, the plasmonic perfect absorber 10 is provided on the conductor layer 13, which is a conductor layer on the side on which the electrode pair 16 is not provided, out of the conductor layer 13 and the conductor layer 15. That is, the conductor layer 13 constitutes the plasmonic perfect absorber 10 together with the insulator layer 12 and the conductor layer 11.

On the other hand, in the thermal radiation element 1A according to the present modification example, a plasmonic perfect absorber 10A is provided on the conductor layer 15, which is a conductor layer on the side on which an electrode pair 16A is provided, out of the conductor layer 13 and the conductor layer 15. That is, the conductor layer 15 constitutes the plasmonic perfect absorber 10A together with the insulator layer 12A and the conductor layer 11A. Note that the insulator layer 12A and the conductor layer 11A constituting the plasmonic perfect absorber 10A are configured in the same manner as the insulator layer 12 and the conductor layer 11 constituting the plasmonic perfect absorber 10. Therefore, in the present modification example, the description thereof is omitted.

In this manner, in an aspect of the present invention, of the conductor layers provided on the principal plane 14a and the principal plane 14b of the substrate 14, the conductor layer provided with the electrode pair 16 is defined as the first conductor layer, and the conductor layer not provided with the electrode pair 16 is defined as the second conductor layer, and the plasmonic perfect absorber may be provided on the first conductor layer (on the side provided with the principal plane 14b) or on the second conductor layer (on the side provided with the principal plane 14a).

### Second Modification Example

The thermal radiation element 1B according to a second modification example of the thermal radiation element 1 will be described with reference to FIG. 6. FIG. 6 is a cross-sectional view of the thermal radiation element 1B, which is a cross-sectional view corresponding to FIG. 2 illustrating the thermal radiation element 1.

In the thermal radiation element 1 illustrated in FIG. 2, a plasmonic perfect absorber is employed as an example of a meta-surface structure provided on one principal plane (principal plane 14a in FIG. 2) side of the substrate 14.

On the other hand, in the thermal radiation element 1B according to the present modification example, a nanoscale rough structure is employed as an example of a meta-surface structure provided on one principal plane (principal plane 14Ba in FIG. 6) side of a substrate 14B. By employing the nanoscale random structure as the meta-surface structure, the band of the emitted electromagnetic waves can be widened as compared with the case of employing the plasmonic perfect absorber.

Note that, in the thermal radiation element 1B, the nanoscale random structure may be formed on a principal plane 14Bb.

### Example

The thermal radiation element 1 as an example of the present invention will be described below. In the present example, the thermal radiation element 1 configured as illustrated in FIG. 2 is employed as a thermal radiation element, and each of the components is designed as follows.

As the substrate 14, a plate-shaped member made of silicon, having a thickness tₛ of 200 μm, and formed in a square shape, 5 mm on each side, was used. The resistivity of this silicon at room temperature was 1 Ωm.

As the conductor layer 15, an HfN film having a thickness t₁₅ of 140 nm was used.

As the conductor layer 13, an HfN film having the thickness t₁₃ of 140 nm was used.

As the insulator layer 12, a SiO₂ film having the thickness t₁₂ of 180 nm was used.

As the conductor layer 11, an HfN film having the thickness t₁₁ of 40 nm was used. Also, as the shape of each of the plurality of conductor patterns 111 constituting the conductor layer 11, a circular shape having a diameter of 400 nm was employed. In addition, as the regular arrangement of the plurality of conductor patterns 111, a square arrangement having a regular space of 650 nm was employed.

As each of the electrodes 161 and 162, an Au film having a thickness of 500 nm was employed. In addition, as the shape of each of the electrodes 161 and 162 in a planar view, a rectangle having a width of 500 μm and a length of 5 mm was employed.

The electric resistivity of HfN employed in the present example was about 1×10⁻³ (Ω·mm), and the electric resistivity of SiO₂ employed in the present example was about 1×10¹⁵ (Ω·mm). Also, in the thermal radiation element 1A in the present example, the plasmonic perfect absorber 10A had a thickness of 340 nm in total.

In the present example, an operating temperature in the range of 350° C. or higher and 500° C. or lower was employed as an example of the operating temperature of the thermal radiation element 1, and the resistance value generated between the electrode 161 and the electrode 162 was measured. Here, the voltage applied between the electrode 161 and the electrode 162 was fixed to 5 V, and the current flowing between the electrode 161 and the electrode 162 was measured. As a result, the resistance values generated between the electrode 161 and the electrode 162 were 6.3 Ω, 5.3 Ω, 4.6Ω, and 4.3Ω at 350° C., 400° C., 450° C., and 500° C., respectively.

In this manner, in the thermal radiation element 1, as the temperature rises, the resistivity of silicon constituting the substrate 14 decreases while the resistivity of HfN constituting the conductor layer 13 and the conductor layer 15 slightly increases. Therefore, as the temperature increased, the resistance value generated between the electrode 161 and the electrode 162 decreased.

In the present example, the spectrum of the electromagnetic waves emitted by the thermal radiation element 1 was measured, and it was confirmed that near-infrared light of 1.0 μm or more and 2.0 μm or less was stably emitted. That is, it has been found that the thermal radiation element 1 in the present example can suitably be used as a thermal radiation light source that stably emits near-infrared light of 1.0 μm or more and 2.0 μm or less in a case where the operating temperature is set to 350° C. or more and 500° C. or less.

[Additional Remarks]

The present invention is not limited to the above-described embodiments, and various modifications can be made within the scope indicated in the claims, and embodiments obtained by appropriately combining technical means disclosed in different embodiments are also included in the technical scope of the present invention.

What is claimed is:

1. A thermal radiation element comprising:
a substrate, made of a semiconductor, having a first principal plane and a second principal plane;
a first conductor layer and a second conductor layer provided on the first principal plane and the second principal plane, respectively; and
an electrode pair provided in an outer edge region of the first conductor layer.

2. The thermal radiation element according to claim 1, further comprising
an insulator layer and a third conductor layer stacked in order on a surface of the first conductor layer or the second conductor layer, the insulator layer and the third conductor layer constituting a plasmonic perfect absorber together with the first conductor layer or the second conductor layer.

3. The thermal radiation element according to claim 2, wherein
the third conductor layer includes a plurality of conductor patterns two-dimensionally and regularly arranged, the plurality of conductor patterns each being in a circular shape or a regular polygonal shape.

4. The thermal radiation element according to claim 3, wherein
a thickness t1 of the conductor layer, out of the first conductor layer and the second conductor layer, constituting the plasmonic perfect absorber together with the insulator layer and the third conductor layer, and a thickness t3 of the third conductor layer satisfies a relationship of t1>1.5×t3.

5. The thermal radiation element according to claim 2, wherein
the conductor layer, out of the first conductor layer and the second conductor layer, constituting the plasmonic perfect absorber together with the insulator layer and the third conductor layer, and the third conductor layer are made of HfN.

6. The thermal radiation element according to claim 2, wherein
the insulator layer is made of at least one of SiO₂, Al₂O₃, and AlN.

7. The thermal radiation element according to claim 1, wherein
a thickness of the substrate is 100 μm or more and 1 mm or less.

8. The thermal radiation element according to claim 1, wherein
the substrate is made of silicon.

9. The thermal radiation element according to claim 1, wherein
the substrate is made of silicon, and
the first principal plane or the second principal plane is provided with a nanoscale rough structure.

10. A thermal radiation element module comprising:
the thermal radiation element according to claim 1; and
a housing provided with a cavity housing the thermal radiation element and a power terminal supplying power to the electrode pair, wherein
in an inside of the cavity, at least a part of the substrate is secured to the cavity using a bonding member.

11. The thermal radiation element module according to claim 10, wherein
in a case where an opening portion of the cavity is viewed in a planar view, the opening portion includes the thermal radiation element,
the opening portion is sealed by an optical window having translucency, and
pressure inside the cavity is lower than pressure outside the cavity.

12. A thermal radiation light source comprising:
the thermal radiation element module according to claim 10.
